(19) United States
(12) Patent Application Publication
(10) Pub. No.: US 2007/0260759 A1
(43) Pub. Date: Nov. 8, 2007

(54) APPARATUS, SYSTEM, AND METHOD FOR COMPLETE DATA MIGRATION FROM A WIRELESS COMMUNICATION DEVICE

(76) Inventor: Willie Lee Scott II, Austin, TX (US)

Correspondence Address: Kunzler & McKenzie, 8 EAST BROADWAY, SUITE 600, SALT LAKE CITY, UT, 84111, US

(21) Appl. No.: 11/279,863

(22) Filed: Apr. 14, 2006

(51) Int. Cl. G06F 3/00

(52) U.S. Cl. 710/8

(57) ABSTRACT

An apparatus, system, and method are disclosed for retrieving data from a portable wireless communication device. An initiation module is included to initiate wireless communication between a portable wireless communication device and the apparatus. The portable wireless communication device is in an off state and the wireless communication is facilitated by a secondary power source in the portable wireless communication device. A location module is included to locate data to be transferred from the portable wireless communication device to the apparatus. A transfer module is included to transfer the located data from the portable wireless communication device to the apparatus via wireless communication.

### BACKGROUND OF THE INVENTION

1. Field of the Invention

This invention relates to portable wireless communication devices and more particularly relates to retrieving data from a portable wireless communication device.

2. Description of the Related Art

Portable wireless communication devices, such as cell phones, personal digital assistants (“PDA”), laptop computers with wireless communication capability, and the like are ever increasingly important in today's society. Data storage capacity on portable wireless communication devices is increasing quickly. Data stored on portable wireless communication devices may be critical or irreplaceable. For example, a user may store important phone numbers on a cell phone without creating another copy of the phone numbers in another place. Addresses, financial information, task lists, and the like may be stored without backup. Loss of data stored on a portable wireless communication device may be merely inconvenient or may be disastrous to a user.

A backup copy of the data on a portable wireless communication device may be created, however, many times a backup operation is not automatic and a user may forget to make timely backup copies. Even if a backup copy of the data on a portable wireless communication device is created, some data may be lost if the current data on a portable wireless communication device becomes inaccessible. Some types of portable wireless communication devices, such as cell phones, typically don't have an available backup procedure to protect data.

Data on a portable wireless communication device may become inaccessible when the portable wireless communication device is lost, stolen, or becomes partially or totally inoperable. Often cell phone users lose important phone numbers, addresses, pictures, music, or other data stored on the cell phone when the phone is lost, stolen, or becomes inoperable for some reason. The same is true for PDAs and laptop computers where the data has not been backed up.

In addition to an owner of a portable wireless communication device being unable to access data on the portable wireless communication device if it is lost or stolen, the data may fall into the hands of someone wanting to illegally use the data. For example, the data may be used in an identity theft scheme. Financial data may be used to illegally steal money from the person who lost the portable wireless communication device. Phone numbers, addresses, and email addresses may be sold to telemarketers, spammers, or the like. A lost or stolen portable wireless communication device may also be used without the owner's consent to make long distance phone calls, use cell phone plan minutes, gain Internet access, etc. which may run up cell phone bills, Internet bills, etc.

From the foregoing discussion, it should be apparent that a need exists for an apparatus, system, and method to retrieve data from a portable wireless communication device. Beneficially, such an apparatus, system, and method would facilitate data retrieval from a lost, stolen, or inoperable portable wireless communication device. Such an apparatus, system, and method may also facilitate removal of data from a portable wireless communication device, disabling the portable wireless communication device, or enabling location of the portable wireless communication device.

### SUMMARY OF THE INVENTION

The present invention has been developed in response to the present state of the art, and in particular, in response to the problems and needs in the art that have not yet been fully solved by currently available data retrieval from a portable wireless communication device. Accordingly, the present invention has been developed to provide an apparatus, system, and method for retrieving data from a portable wireless communication device that overcome many or all of the above-discussed shortcomings in the art.

A method of the present invention is also presented for retrieving data from a portable wireless communication device. The method in the disclosed embodiments substantially includes the steps necessary to carry out the functions presented above with respect to the operation of the described apparatus and system. In one embodiment, the method includes initiating wireless communication between a portable wireless communication device and a computer. The portable wireless communication device is in an off state and the wireless communication is facilitated by a secondary power source in the portable wireless communication device. The method also includes locating data to be transferred from the portable wireless communication device to the computer and transferring the located data from the portable wireless communication device to the computer via wireless communication.

In a further embodiment, initiating wireless communication includes toggling on a switch in the portable wireless communication device to enable wireless communication with the computer. In another embodiment, the method includes disabling access to data stored on the portable wireless communication device in response to transferring at least a portion of the located data to the computer. In another embodiment, disabling access to data includes removing data stored on the portable wireless communication device.

In one embodiment, transferring data also includes prioritizing the located data and transferring the located data in order of priority. In another embodiment, the method further includes disabling at least one function of the portable wireless communication device. In another embodiment, the portable wireless communication device provides no indication to a user regarding the wireless communication between the portable wireless communication device and the computer. In yet another embodiment, the off state includes a main power source of the portable wireless communication device in a substantially depleted state. In an alternate embodiment, the off state includes the portable wireless communication device switched off.

In one example, the secondary power source is a battery. In another example, the secondary power source is a capacitor. The portable wireless communication device, in one example, is a cell phone. In another example, the portable wireless communication device is a Personal Digital Assistant (“PDA”). In yet another example, portable wireless communication device is a portable wireless computer.

A system of the present invention is also presented to retrieve data from a portable wireless communication device. The system may be embodied by a wireless communication device, a portable wireless communication device, and a computer with access to the wireless communication network. In particular, the computer includes an initiation module that initiates wireless communication between the portable wireless communication device and the computer through the wireless communication network. The portable wireless communication device provides substantially no user interface indication of the wireless communication between the portable wireless communication device and the computer. The computer includes a location module that locates data to be transferred from the portable wireless communication device to the computer and a transfer module that transfers the located data from the portable wireless communication device to the computer via wireless communication.

In one embodiment, the portable wireless communication device is in an off state and the wireless communication is enabled by a secondary power source in the portable wireless communication device. In another embodiment, the wireless communication network is a secondary wireless communication network and the portable wireless communication device communicates with the computer over a primary wireless communication network for normal operation and over the secondary wireless communication network to transfer the located data.

An apparatus to retrieve data from a portable wireless communication device is provided with a plurality of modules configured to functionally execute the necessary steps of retrieving data from a portable wireless communication device that is lost, stolen, or broken. These modules in the described embodiments include an initiation module that initiates wireless communication between a portable wireless communication device and the apparatus. The portable wireless communication device is in an off state and the wireless communication is facilitated by a secondary power source in the portable wireless communication device. The apparatus includes a location module that locates data to be transferred from the portable wireless communication device to the apparatus. The apparatus includes a transfer module that transfers the located data from the portable wireless communication device to the apparatus via wireless communication.

The apparatus, in one embodiment, is a second portable wireless communication device. In another embodiment, the apparatus is a computer. In yet another embodiment, the apparatus is a server. The apparatus is further configured, in one embodiment, to include a device location module that determines the location of the portable wireless communication device. In another embodiment, the apparatus includes a disable module that disables at least a portion of the functionality of the portable wireless communication device.

An apparatus to transmit data from a portable wireless communication device is provided with a plurality of modules configured to functionally execute the necessary steps of retrieving data from a portable wireless communication device that is lost, stolen, or broken. These modules in the described embodiments include a response module that responds to a wireless communication request from a computer to initiate wireless communication between a portable wireless communication device and the computer. The portable wireless communication device is in an off state and the wireless communication is facilitated by a secondary power source in the portable wireless communication device. The apparatus includes a data selection module that locates data to be transferred from the portable wireless communication device to the computer and a data transfer module that transfers the located data from the portable wireless communication device to the computer via wireless communication.

In one embodiment, the response module further includes a switch module that toggles on a switch in the portable wireless communication device to enable the wireless communication with the computer. In another embodiment, the response module also includes a security module that authenticates validity of the wireless communication request from the computer to initiate the wireless communication.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for retrieving data from a portable wireless communication device in accordance with the present invention;

FIG. 2 is a schematic block diagram illustrating an alternate embodiment of a system for retrieving data from a portable wireless communication device in accordance with the present invention;

FIG. 3 is a schematic block diagram illustrating one embodiment of an apparatus for retrieving data from a portable wireless communication device in accordance with the present invention;

FIG. 4 is a schematic block diagram illustrating one embodiment of an apparatus to transmit data from a portable wireless communication device in accordance with the present invention;

FIG. 5 is a schematic flow chart diagram illustrating one embodiment of a method for retrieving data from a portable wireless communication device in accordance with the present invention; and

FIG. 6 is a schematic flow chart diagram illustrating a more detailed embodiment of a method for retrieving data from a portable wireless communication device when the portable wireless communication device is lost or stolen in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams described herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

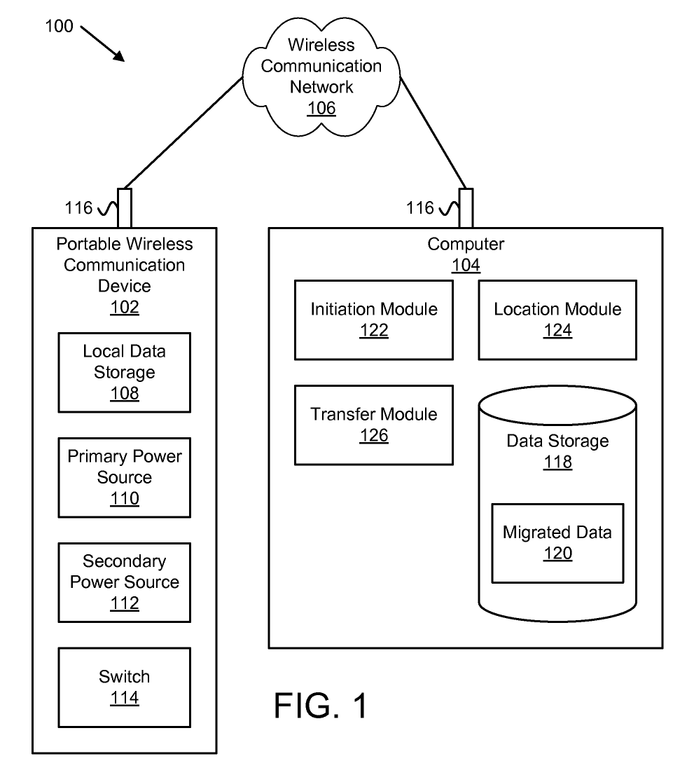

FIG. 1 depicts a schematic block diagram illustrating one embodiment of a system 100 for retrieving data from a portable wireless communication device 102 in accordance with the present invention. The system 100 includes the portable wireless communication device 102 in communication with a computer 104 through a wireless communication network 106. The portable wireless communication device 102 includes local data storage 108 and a primary power source 110. The portable wireless communication device 102 may also include, in one embodiment, a secondary power source 112, a switch 114 and an antenna 116. The computer 104 includes data storage 118 with a location to store migrated data 120. The computer 104 also includes, in one embodiment, an initiation module 122, a location module 124, and a transfer module 126. In one embodiment, the computer 104 includes an antenna 116. The components and modules of the system 100 identified above will be described in detail below.

The local storage 108 of the portable wireless communication device 102 includes data stored by an owner of the portable wireless communication device 102 or by a service provider, such as a cellular service provider, an Internet service provider (“ISP”), or the like. The local data storage 108 typically stores data accessible during normal operation of the portable wireless communication device 102 by a user or service provider. The data may include phone numbers, addresses, digital pictures, digital music, data files, application data, application executable files, etc. The data on the local data storage 108 is also accessible to the computer 104 through the wireless communication network 106 in the invention described herein.

The portable wireless communication device 102 also includes a primary power source 110. The primary power source 110 is typically used for normal operation of the portable wireless communication device 102 and is typically of the type normally found in cell phones, PDAs, and laptop computers. For example, the primary power source 110 may be used to make a phone call, send an email, access data, run an application, store data, run an operating system, play music, take a photograph, etc. The primary power source 110 may comprise a battery or a power supply connected to an alternating current source. The primary power source 110 may include monitoring and charging circuitry. One of skill in the art will recognize other types and functions of a primary power source 110 appropriate for typical operation of a portable wireless communication device 102.

The portable wireless communication device 102 includes, in one embodiment, a secondary power source 112 configured to facilitate communication with the computer 104 through a wireless communication network 106 when the portable wireless communication device 102 is in an off state. The secondary power source 112 is preferably a long-life power source providing at least enough power to facilitate communication with the computer 104 through a wireless communication network 106, selection of data to transfer, and transfer of data to the computer 104. The secondary power source 112 may be recharged by the primary power source 112 or another power source in the portable wireless communication device 102. In one embodiment, the secondary power source 112 is a battery, such as a lithium battery or a nickel cadmium battery. In another embodiment, the secondary power source 112 is a fuel cell. In yet another embodiment, the secondary power source 112 is a capacitor. The secondary power source 112 may include any power source capable of remaining charged either independently or by recharging while inactive and capable of providing adequate energy to facilitate communication with the computer 104 through a wireless communication network 106, allow selection of data to transfer, and to transfer data to the computer 104.

In one embodiment, the portable wireless communication device 102 includes a switch 114 configured to facilitate communication with the computer 104 through the wireless communication network 106. The switch 114 may be an electronic switch or soft switch configured to enable the secondary power source 112. In one embodiment, monitoring circuitry and/or software of the switch 114 derives power from the primary power source 110 or the secondary power source 112. The monitoring circuitry and/or software may derive power from the primary power source 110 until the primary power source 110 can no longer provide enough energy to the monitoring circuitry and/or software and then derive power from the secondary power source 112.

In one embodiment, the monitoring circuitry and/or software of the switch 114 facilitate monitoring or listening for a signal from the computer 104 through the wireless communication network 106 requesting initiation of wireless communication with the computer 104 for the purpose of transferring data from the local data storage 108 to the computer 104. When the monitoring circuitry and/or software of the switch 114 receive such a signal, the switch 114 may activate the secondary power source 112 to facilitate data selection and transfer to the computer 104. In another embodiment, the monitoring circuitry and/or software detect a signal from the computer 104 and the switch 114 does not connect the secondary power source 112, but instead facilitates the requested wireless communication using the primary power source 110. One of skill in the art will recognize other means to detect a request to initiate wireless communication with the computer 104, to transfer data, and means to facilitate activation of a secondary power source 112 when desirable to provide energy to transfer data to a computer 104. The portable wireless communication device 102 may also include an antenna 116 configured for wireless communication.

Beneficially, a secondary power source 112 in a portable wireless communication device 102 provides a way to transfer data from the portable wireless communication device 102 to the computer 104 after the portable wireless communication device 102 has been lost, stolen, or is inoperable in some way. The secondary power source 112 may provide enough power for retrieval of data from the local data storage 108 in the portable wireless communication device 102 even when the portable wireless communication device 102 is in an off state, the primary power source 110, such as a battery, is depleted or removed, or the portable wireless communication device 102 is inoperable for normal operation. The secondary power source 112 may also include enough energy to delete or disable access to the data in the local data storage 108, activate a location function in the portable wireless communication device 102, such as global position satellite (“GPS”) tracking, or disable one or more functions of the portable wireless communication device 102 to make it inoperable. One of skill in the art will recognize other uses and benefits of a secondary power source 112 in a portable wireless communication device 102 facilitating wireless data transfer to a computer 104.

The computer 104 includes data storage 118 configured to store migrated data 120 from the portable wireless communication device 102. The data storage 118 may include a hard disk drive, an optical drive, tape storage, flash memory, random access memory (“RAM”), etc. Migrated data 120 transferred from the portable wireless communication device 102 may be stored in the data storage 118 on the computer 104 momentarily, temporarily, or permanently. Migrated data 120 may also be stored in the data storage 118 in RAM and then in persistent storage such as a hard disk drive, tape drive, or the like. Migrated data 120 may also be stored on the computer 104 in data storage 118, such as RAM or persistent storage, briefly or for a longer period of time before being moved to a destination portable wireless communication device. One of skill in the art will recognize other forms of data storage 118 on a computer 104 suitable for migrated data 120 transferred from a portable wireless communication device 102.

In one embodiment, the computer 104 includes an initiation module 122 configured to initiate wireless communication between the portable wireless communication device 102 and the computer 104. In one embodiment, the portable wireless communication device 102 is in an off state and the wireless communication is facilitated by the secondary power source 112 in the portable wireless communication device 102. The secondary power source 112 facilitates wireless communication by providing the power necessary for wireless communication when the primary power source 110 is unavailable for some reason. The wireless communication may be facilitated by the switch 114 activating the secondary power source 112. In another embodiment, the initiation module 122 initiates wireless communication with the portable wireless communication device 102 when the portable wireless communication device 102 is operational and using the primary power source 110.

In one embodiment, the initiation module 122 initiates wireless communication with the portable wireless communication device 102 without providing any substantial user interface indication of the wireless communication between the portable wireless communication device 102 and the computer 104. The initiation module 122 may also initiate wireless communication with the portable wireless communication device 102 while a possessor of the portable wireless communication device 102 is unaware of the communication and without authorization of the possessor. Wireless communication without providing any indication on a user interface is beneficial to prevent a person illegally in possession of the portable wireless communication device 102 from interfering with the wireless communication. For example, a thief in possession of the portable wireless communication device 102 may be prevented from interfering with wireless communication resulting in transfer of data from the portable wireless communication device 102, disabling data on the portable wireless communication device 102, or disabling the portable wireless communication device 102.

In one embodiment, the initiation module 122 initiates wireless communication over a wireless communication network 106 primarily used by the portable wireless communication device 102 for normal communication. In another embodiment, the initiation module 122 initiates wireless communication over a wireless communication network 106 not normally used by the portable wireless communication device 102, such as a secondary wireless communication network (not shown). For example, the secondary wireless communication network may be a Bluetooth® network. The secondary wireless communication network may be available even if the portable wireless communication device 102 is unable to communicate over a primary wireless communication network 106.

Beneficially, the initiation module 122 may initiate wireless communication with a portable wireless communication device 102 that has been lost or stolen. The initiation module 122 may initiate wireless communication with the portable wireless communication device 102 even when a primary power source 110 is depleted or the portable wireless communication device 102 is switched off. The initiation module 122 may also initiate wireless communication without the person illegally in possession of the portable wireless communication device 102 or a person that may have found the portable wireless communication device 102 authorizing the communication or even knowing about the communication.

In another embodiment, the initiation module 122 may initiate wireless communication with a portable wireless communication device 102 that is unable to operate in a normal communication mode for some reason, but still is capable of communicating with the computer 104. For example, the portable wireless communication device 102 may have lost the ability to connect to the primary power source 110, may have a broken display, or may have a broken keypad. One of skill in the art will recognize other ways for an initiation module 122 to initiate wireless communication with a portable wireless communication device 102 that is lost, stolen, broken, etc. with or without authorization of a current possessor of the portable wireless communication device 102 and with or without the current possessor of the portable wireless communication device 102 having knowledge of the wireless communication.

The computer 104 may also include a location module 124 configured to locate data to be transferred from the portable wireless communication device 102 to the computer 104. In one embodiment, the data on the portable wireless communication device 102 to be transferred to the computer 104 is located in a specific location in the local data storage 108 and the location module 124 locates data in the predetermined location. In another embodiment, the location module 124 locates critical data in the local data storage 108. In another embodiment, the location module 124 selects for transfer all accessible data contained on the portable wireless communication device 102 to be transferred. In another embodiment, the location module 124 selects only a portion of the data on the portable wireless communication device 102. The portion of data may be, in one embodiment, data stored on the portable wireless communication device 102 since a last data backup operation. In yet another embodiment, the location module 124 locates data stored on the portable wireless communication device 102 by an owner of the portable wireless communication device 102 and selects the data for transfer.

In one embodiment, the location module 124 permits an owner of the portable wireless communication device 102 or another person to select data to be transferred from the portable wireless communication device 102 to the computer 104. In another embodiment, the location module 124 allows an application running on the computer 104 to locate and select data to be transferred. The user may operate the application running on the computer 104. One of skill in the art will recognize other ways to locate and/or select all or a portion of data stored on a portable wireless communication device 102 to be transferred to the computer 104.

The computer 104 may also include a transfer module 126 configured to transfer the located data from the portable wireless communication device 102 to the computer 104 via wireless communication. In one embodiment, the transfer module 126 prioritizes data on the local data storage 108 to be transferred. Prioritizing the data is beneficial because the secondary power source 112 may not have enough stored energy to transfer all of the data desired to be transferred to the computer 104. For example, on a cellular phone contact information such as phone numbers and addresses may be a higher priority than digital photos so transferring the contact information before transferring the photos may be desirable when the secondary power source 112 does not include enough energy to transfer the contacts and the photos. The transfer module 126 transfers data in order of priority until the secondary power source 112 is depleted or all the data is transferred.

The located data may be transferred preferably without providing any user interface indication of the data transfer to the computer 104. In one embodiment, the located data is transferred all together. In another embodiment, only a portion of the located data is transferred at one time during one transfer session. One of skill in the art will recognize other ways for the transfer module 126 to transfer the located data from the portable wireless communication device 102 to the computer 104.

Beneficially, the system 100 provides a way for an owner of a portable wireless communication device 102 to recover data from the local data storage 108 on the portable wireless communication device 102 when the portable wireless communication device 102 is stolen, lost, or inoperable to some degree. Providing a secondary power source 112 in the portable wireless communication device 102 allows access to data on the portable wireless communication device 102 even when the portable wireless communication device 102 is switched off or a primary power source 110 on the portable wireless communication device 102 is depleted. A switch 114 in the portable wireless communication device 102 may provide a convenient way to connect the secondary power source 112 to facilitate transmission of data from the portable wireless communication device 102 to the computer 104.

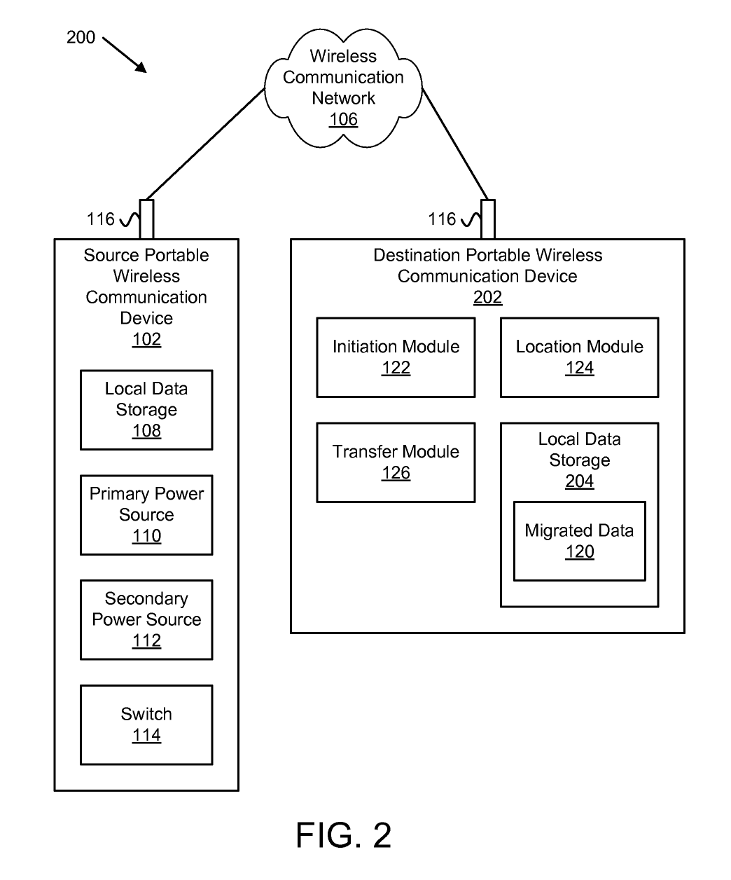

FIG. 2 is a schematic block diagram illustrating an alternate embodiment of a system 200 for retrieving data from a portable wireless communication device 102 in accordance with the present invention. The system 200 includes a wireless communication network 106 and a portable wireless communication device 102, or source portable wireless communication device 102, substantially similar as described in relation to the system 100 in FIG. 1. The source portable wireless communication device 102 includes an antenna 116, local data storage 108, a primary power source 110, a secondary power source 112, and a switch 114 substantially similar as described in relation to the system 100 in FIG. 1. The system 200 also includes a destination portable wireless communication device 202. The destination portable wireless communication device 202 includes local data storage 204 with capacity for migrated data 120 transferred from the source portable wireless communication device 102. The destination portable wireless communication device 202, in one embodiment, includes an antenna 116, an initiation module 122, a location module 124, and a transfer module 126 substantially similar as described in relation to the system 100 in FIG. 1.

In one embodiment, the initiation module 122 initiates communication with the source portable wireless communication device 102 over a wireless communication network 106 used by the source portable wireless communication device 102 for normal communication. In another embodiment, the initiation module 122, the location module 124, and the transfer module 126 in the destination portable wireless communication device 202 communicate with the source portable wireless communication device 102 over the wireless communication network 106 directly. In another embodiment, the initiation module 122, the location module 124, and the transfer module 126 communicate with the source portable wireless communication device 102 indirectly through a computer 104. The transfer module 126 may store data temporarily on the computer 104, for example in the computer's 104 RAM, or may transfer data directly from the source portable wireless communication device 102 to the destination portable wireless communication device 202.

In one embodiment, the destination portable wireless communication device 202 communicates with the source portable wireless communication device 102 over a second wireless communication network (not shown). The initiation module 122 initiates wireless communication with the source portable wireless communication device 102 when the destination portable wireless communication device 202 comes within range of the second wireless communication network. In another example, the source portable wireless communication device 102 is broken and cannot communicate over the functioning primary wireless communication network 106 but can communicate over the second wireless communication network. The initiation module 122 initiates wireless communication between the source portable wireless communication device 102 and the destination portable wireless communication device 202 (or computer 104 for the system 100 described in FIG. 1) over the second wireless communication network.

In yet another example, the primary wireless communication network 106 is not operational and the initiation module 122 initiates wireless communication between the source portable wireless communication device 102 and either the computer 104 or a destination portable wireless communication device 202 over the second wireless communication network. One of skill in the art will recognize other situations where an initiation module 122, a location module 124, and a transfer module 126 on a destination portable wireless communication device 202 may communicate with a source portable wireless communication device 102 to transfer data from the source portable wireless communication device 102 to the destination portable wireless communication device 202.

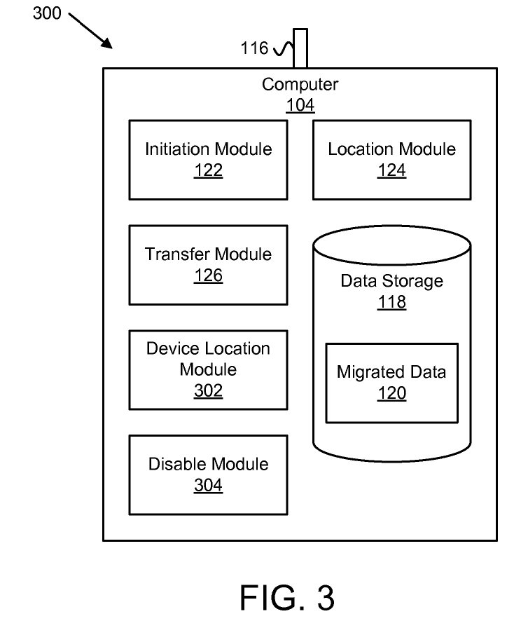

FIG. 3 is a schematic block diagram illustrating one embodiment of an apparatus 300 for retrieving data from a portable wireless communication device 102 in accordance with the present invention. The apparatus 300, in one embodiment, includes an initiation module 122, a location module 124, a transfer module 126, and data storage 118 with capacity for migrated data 120 that are substantially similar to like numbered components described in relation to the system 100 described in FIG. 1. The apparatus 300 may be embodied by a computer 104. All or a portion of the initiation module 122, the location module 124, and the transfer module 126 may be located on the computer 104, a destination portable wireless communication device 202, or another device. In one embodiment, the apparatus 300 includes a device location module 302 configured to locate the portable wireless communication device 102. The device location module 302, in one embodiment, activates GPS tracking in the portable wireless communication device 102 and provides coordinates for locating the portable wireless communication device 102.

In another embodiment, the device location module 302 activates GPS tracking in the portable wireless communication device 102 for police or others to use a GPS network to determine the physical location of the portable wireless communication device 102. In another embodiment, the device location module 302 may triangulate the location of the portable wireless communication device 102 using transmission equipment of the wireless communication network 106 to provide a location of the portable wireless communication device 102. In yet another embodiment, the device location module 302 activates a tracking beacon in the portable wireless communication device 102 configured to allow tracking of the portable wireless communication device 102. In one embodiment, operation of the device location module 302 may be undetectable to a user of the portable wireless communication device 102. One of skill in the art will recognize other ways that the device location module 302 may locate the portable wireless communication device 102.

In one embodiment, the apparatus 300 includes a disable module 304. The disable module 304 may be configured to disable at least a portion of the functionality of the portable wireless communication device 102. For example, the disable module 304 may permanently or temporarily prevent the portable wireless communication device 102 from being turned on. In another example, the disable module 304 disables the primary power source 110 of the portable wireless communication device 102. In another example, the disable module 304 destroys circuits or memory in the portable wireless communication device 102. In yet another example, the disable module 304 prevents the portable wireless communication device 102 from using wireless communication over the wireless communication network 106. In one embodiment, the disable module 304 disables access to data stored in local data storage 108 in the portable wireless communication device 102. In this embodiment, the disable module 304 may disable access to data by transferring or deleting the data from the portable wireless communication device 102. One of skill in the art will recognize other ways the disable module 304 may disable at least a portion of the functionality of the portable wireless communication device 102 or disables access to data stored on the portable wireless communication device 102.

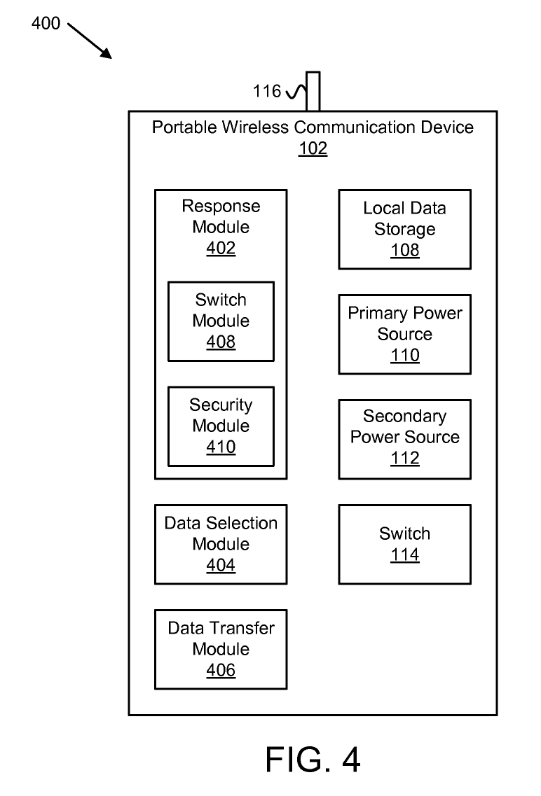

FIG. 4 is a schematic block diagram illustrating one embodiment of an apparatus 400 to transmit data from a portable wireless communication device 102 in accordance with the present invention. The apparatus 400 includes a portable wireless communication device 102 with an antenna 116, local data storage 108, a primary power source 110, a secondary power source 112, and a switch 114 substantially similar to those described in relation to the system 100 of FIG. 1. The portable wireless communication device 102 includes, in one embodiment, a response module 402, a data selection module 404, and a data transfer module 406. The response module 402 may include a switch module 408 and a security module 410. The modules in the portable wireless communication device 102 are described in detail below.

The apparatus 400, in one embodiment, includes a response module 402 configured to respond to a wireless communication request from a computer 104 to initiate wireless communication between the portable wireless communication device 102 and the computer 104. The response module 402 may respond to a wireless communication request while the portable wireless communication device 102 is in an “off” state or an “on” state. The response module 402 may respond to a wireless communication request while at least a portion of the portable wireless communication device 102 is powered by a secondary power source 112 or by a primary power source 110 in the portable wireless communication device 102.

The response module 402 may monitor wireless communication for a request from the computer 104 to transfer data. The response module 402 may receive energy to monitor and respond from the primary power source 110, the secondary power source 112, or another power source in or connected to the portable wireless communication device 102. In gone embodiment, the response module 402 receives energy to monitor wireless communication from the primary power source 110 and then from the secondary power source 112 when the primary power source 110 is no longer available. In another embodiment, the response module 402 receives a request to initiate wireless communication from the initiation module 122 of a computer 104.

The apparatus 400 may include a data selection module 404 configured to locate data to be transferred from the portable wireless communication device 102 to the computer 104. The data selection module 404 locates data, in one embodiment, in a pre-selected location in the local data storage 108. In another embodiment, the data selection module 404 locates data in response to a command from the computer 104 over the wireless communication network 106. The command from the computer 104 may be from the location module 124 and the location module 124 may operate as described in relation to the system 100 of FIG. 1. One of skill in the art will recognize other ways for the data selection module 404 to locate data to be transferred from the portable wireless communication device 102 to the computer 104 or to a destination portable wireless communication device 202.

The apparatus 400 may include a data transfer module 406 configured to transfer the located data from the portable wireless communication device 102 to the computer 104 via wireless communication. The data transfer module 406, in one embodiment, may prioritize the data to be transferred. In another embodiment, the data transfer module 406 transfers data to the computer 104 in response to a command from the transfer module 126 on the computer 104.

In one embodiment, the response module 402 includes a switch module 408 configured to toggle on the switch 114 in the portable wireless communication device 102 to enable wireless communication with the computer 104. The switch module 408 may toggle the switch 114 to connect the secondary power source 112 to the portable wireless communication device 102 in response to the primary power source 110 being unavailable. For example, the primary power source 110 may be depleted, disconnected, or removed. In another embodiment, the switch module 408 toggles the switch 114 to connect to the secondary power source 112 when the response module 402 receives a wireless communication request and the primary power source 110 is unavailable. The switch module 408 may connect the secondary power source 112 and power on modules of the portable wireless communication device 102 required to transmit data from the portable wireless communication device 102 to the computer 104 or a destination portable wireless communication device 202.

In another embodiment, the response module 402 includes a security module 410 configure to authenticate the validity of the request from the computer 104 to initiate wireless communication. The security module 410, in one embodiment, recognizes a password in a transmission from the computer 104. In another embodiment, the security module 410 uses a public and/or a private key of an encryption technique to authenticate the validity of the request from the computer 104. If the security module 410 does not validate the request, the security module 410 may discontinue communication with the computer 104, may send a message to the computer 104, may display a message on a user interface of the portable wireless communication device 102, or may take some other appropriate action. If the security module 410 validates the request, the response module 402 responds to the request. One of skill in the art will recognize other ways a security module 410 may authenticate the validity of a request from a computer 104 to initiate wireless communication.

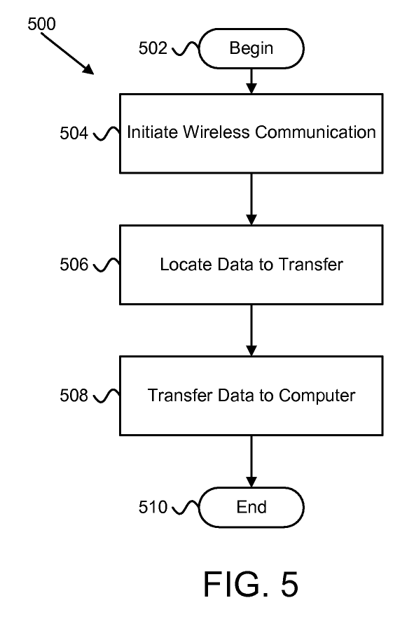

FIG. 5 is a schematic flow chart diagram illustrating one embodiment of a method 500 for retrieving data from a portable wireless communication device 102 in accordance with the present invention. The method 500 begins 502 and the initiation module 122 initiates 504 wireless communication between the portable wireless communication device 102 and the computer 104 or destination portable wireless communication device 202. In one embodiment, the portable wireless communication device 102 is in an “off” state. In another embodiment, the portable wireless communication device 102 is in an “on” state. In another embodiment, the secondary power source 112 in the portable wireless communication device 102 facilitates the wireless communication. In yet another embodiment, the primary power source 110 in the portable wireless communication device 102 facilitates the wireless communication. The security module 410, in one embodiment, authenticates the validity of the request from the initiation module 122 to initiate communication. The switch module 408 may toggle the switch 114 to facilitate or enable the wireless communication by connecting a secondary power source 112 if the primary power source 110 is unavailable.

The location module 124 locates 506 data to be transferred from the portable wireless communication device 102 to the computer 104 or destination portable wireless communication device 202. The location module 124, in one embodiment, may locate 506 data in the local data storage 108 on the portable wireless communication device 102 in a predetermined location, may select all data, may select all user data, may allow selection of a portion of the data, etc. The transfer module 126 then transfers 508 the located data to the computer 104 or destination portable wireless communication device 202 and the method 500 ends 510.

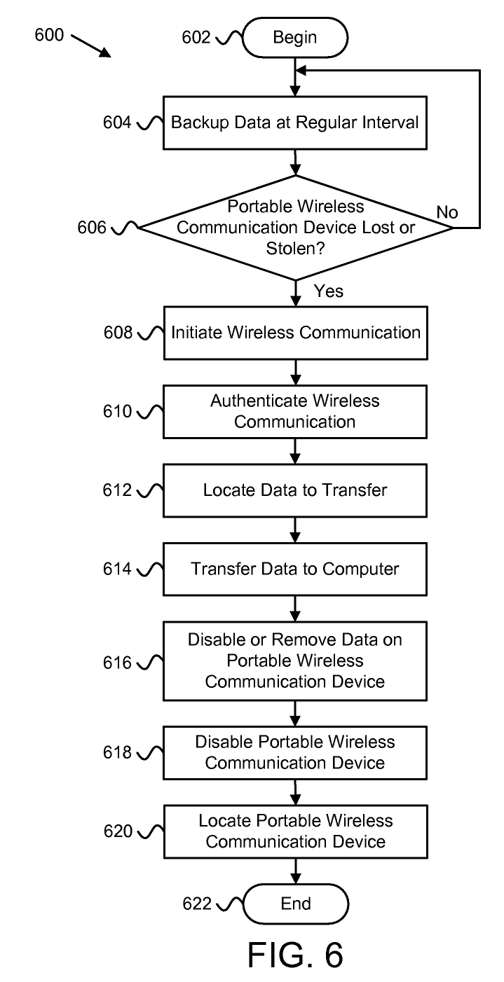

FIG. 6 is a schematic flow chart diagram illustrating a more detailed embodiment of a method 600 for retrieving data from a portable wireless communication device 102 when the portable wireless communication device 102 is lost or stolen in accordance with the present invention. The method 600 begins 602 and the computer 104 backs up 604 data stored in the local data storage 108 of the portable wireless communication device 102 to the computer 104 at a regular interval. The computer 104 determines 606 if the portable wireless communication device 102 is lost or stolen. The computer 104 may determine 606, in one embodiment, that the portable wireless communication device 102 is lost or stolen by receiving input from an owner of the portable wireless communication device 102. In another embodiment, an administrator of the computer 104 receives information that the portable wireless communication device 102 is lost or stolen and notifies the computer 104. One of skill in the art will recognize other ways to determine 606 that the portable wireless communication device 102 is lost or stolen. If the computer 104 determines 606 that the portable wireless communication device 102 is not lost or stolen, the method 600 returns and the computer 104 backs up data from the portable wireless communication device 102 to the computer 104 at the next regular time interval.

If the computer 104 determines 606 that the portable wireless communication device 102 is lost or stolen, the initiation module 122 initiates 608 wireless communication between the portable wireless communication device 102 and the computer 104. The security module 410 authenticates 610 the validity of the request for wireless communication from the computer 104. The location module 124 locates 612 data in the local data storage 108 of the portable wireless communication device 102 to be transferred to the computer 104. The transfer module 126 transfers 614 data from the portable wireless communication device 102 to the data storage 118 of the computer 104.

The disable module 304, in one embodiment, disables 616 access to data on the portable wireless communication device 102. In another embodiment, the disable module 304 removes 616 data from the portable wireless communication device 102. In another embodiment, the disable module 304 disables 618 at least one function of the portable wireless communication device 102. For example, the disable module 304 may disable 618 the ability to manually turn on the portable wireless communication device 102. In another example, the disable module 304 may disable 618 wireless communication from the portable wireless communication device 102. One of skill in the art will recognize other ways that the disable module 304 may disable or remove data and/or disable at least some functionality of the portable wireless communication device 102. The device location module 302, in one embodiment, locates 620 the portable wireless communication device 102 and the method 600 ends 622.

The method 600 may also be used to retrieve data from a partially broken portable wireless communication device 102. The method 600 may be altered as needed or desired by the owner of the portable wireless communication device 102 or a wireless communications provider. The present invention provides a convenient way to recover data from a portable wireless communication device 102 that is lost, stolen, or broken. Providing a secondary power source 112 and some type of switch 114 to enable the secondary power source 112 allows data retrieval when the portable wireless communication device 102 is off or the primary power source 110 is unavailable.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code programmed for retrieving data from a portable wireless communication device, the operations of the computer program product comprising:
receiving at a portable wireless communication device a wireless communication request from a computer to initiate wireless communication, wherein the portable wireless communication device is in an off state and the wireless communication is facilitated by a secondary power source in the portable wireless communication device;
locating data to be transferred from the portable wireless communication device to the computer; and
transferring the located data from the portable wireless communication device to the computer via wireless communication.

2. The computer program product of claim 1, wherein receiving a wireless communication request further comprises toggling on a switch in the portable wireless communication device to enable wireless communication with the computer.

3. The computer program product of claim 1, further comprising disabling access to data stored on the portable wireless communication device in response to transferring at least a portion of the located data to the computer.

4. The computer program product of claim 3, wherein disabling access to data comprises removing data stored on the portable wireless communication device.

5. The computer program product of claim 1, wherein transferring data further comprises prioritizing the located data and transferring the located data in order of priority.

6. The computer program product of claim 1, further comprising disabling at least one function of the portable wireless communication device.

7. The computer program product of claim 1, wherein the portable wireless communication device provides no indication to a user regarding the wireless communication between the portable wireless communication device and the computer.

8. The computer program product of claim 1, wherein the off state comprises a main power source of the portable wireless communication device in a substantially depleted state.

9. The computer program product of claim 1, wherein the off state comprises the portable wireless communication device switched off.

10. The computer program product of claim 1, wherein the secondary power source is selected from the group consisting of a battery and a capacitor.

11. The computer program product of claim 1, wherein the portable wireless communication device is selected from the group consisting of a cell phone, a Personal Digital Assistant (“PDA”) and a portable wireless computer.

12. The computer program product of claim 1, wherein at least one communication function of the portable wireless communication device is inoperable for normal communication of the portable wireless communication device.

13. A system method for retrieving data from a portable wireless communication device, the system method comprising:
initiating wireless communication between a portable wireless communication device and a computer;
transmitting a request to the portable wireless communication device to switch to a secondary power source in the portable wireless communication device; and
transmitting a request to the portable wireless communication device to transfer data from a pre-defined location on the portable wireless communication device to the computer via wireless communication and receiving the data.

14. The method of claim 13, further comprising browsing data in the pre-defined location and wherein the request to transfer data comprises a request to transmit selected data from the pre-defined location.

15. The system method of claim 13, wherein the portable wireless communication device communicates with the computer over a primary wireless communication network for normal operation and over a secondary wireless communication network to transfer the data.

16. A computer program product comprising a computer readable medium having computer usable program code programmed to retrieve data from a portable wireless communication device, the operations of the computer program product comprising:
initiating wireless communication between a portable wireless communication device and a computer;
transmitting a request to the portable wireless communication device to switch to a secondary power source in the portable wireless communication device; and
transmitting a request to the portable wireless communication device to transfer data from a pre-selected location on the portable wireless communication device to the computer via wireless communication and receiving the data.

17. The computer program product of claim 16, wherein the computer is one of a group consisting of a second portable wireless communication device and a server.

18. The computer program product of claim 16, further comprising determining the location of the portable wireless communication device.

19. The computer program product of claim 16, further comprising disabling at least a portion of the functionality of the portable wireless communication device.

20. An apparatus to transmit data from a portable wireless communication device, the apparatus comprising:
a response module configured to respond to a wireless communication request from a computer to initiate wireless communication between a portable wireless communication device and the computer, wherein the portable wireless communication device is in an off state and the wireless communication is facilitated by a secondary power source in the portable wireless communication device;
a data selection module configured to locate data to be transferred from the portable wireless communication device to the computer; and
a data transfer module configured to transfer the located data from the portable wireless communication device to the computer via wireless communication.

21. The apparatus of claim 20, wherein the response module further comprises a switch module configured to toggle on a switch in the portable wireless communication device to enable the wireless communication with the computer.

22. The apparatus of claim 20, wherein the response module further comprises a security module configured to authenticate validity of the wireless communication request from the computer to initiate the wireless communication.
